(19) United States
(12) Patent Application Publication
(10) Pub. No.: US 2011/0044574 A1
(43) Pub. Date: Feb. 24, 2011

(54) METHODS AND SYSTEMS OF INSTALLING CABLE FOR MEASUREMENT OF A PHYSICAL PARAMETER

(76) Inventor: Andrew Strong, Romsey (GB)

Correspondence Address: SCHLUMBERGER OILFIELD SERVICES, 200 GILLINGHAM LANE, MD 200-9, SUGAR LAND, TX, 77478, US

(21) Appl. No.: 12/672,527

(22) PCT Filed: Aug. 5, 2008
(86) PCT No.: PCT/GB2008/002649

§ 371 Date: Nov. 9, 2010

Related U.S. Application Data
(60) Provisional application No. 60/964,294, filed on Aug. 10, 2007.

(51) Int. Cl. G01D 5/353; G01L 1/24; G02B 6/036

(52) U.S. Cl. 385/12; 73/800; 264/1.28

(57) ABSTRACT

A method of installing a cable for the distributed measurement of a physical parameter, includes providing a cable adapted to measure a physical parameter at a plurality of points along the carrier tube, inserting the cable through a carrier tube, injecting a hardenable fluid into the carrier tube, and hardening the hardenable fluid material to be in a substantially solid state.

### BACKGROUND OF THE INVENTION

This invention relate to methods and systems of installing a cable for the measurement of a physical parameter.

There are widely recognized needs to make measurements for conditions on a long linear asset, such as terrestrial and subsea pipelines, subsea risers, and off-loading lines. These pipelines can extend over many kilometers. To monitor the pipelines, sensors may be deployed. Optical fibers with sensor units can be used to convey detection signals from sensors measuring various parameters including, for example, temperature, pressure, stress, and strain. Such an optical fiber system is disclosed in U.S. Pat. No. 6,817,257, which is herein incorporated by reference in its entirety.

### SUMMARY

In one aspect, embodiments disclosed herein relate to a method of installing a cable for the distributed measurement of a physical parameter, comprising: providing a cable adapted to measure a physical parameter at a plurality of points along the carrier tube; inserting the cable through a carrier tube; injecting a hardenable fluid into the carrier tube; and hardening the hardenable fluid material to be in a substantially solid state.

In another aspect, embodiments disclosed herein relate to a system for the measurement of a physical parameter, comprising: a carrier tube; a cable disposed in the carrier tube and configured to measure strain at at least one point around the carrier tube; and a hardenable fluid material provided around the cable to allow strain coupling between the cable and the carrier tube.

Other featured and advantages of the invention will be apparent from the following description and the appended claims.

### BRIEF DESCRIPTION OF THE DRAWINGS

FIG. 1 is a schematic drawing of a system for installing an optical fiber cable through a carrier tube in accordance with one embodiment of the present invention.

FIG. 2A is a longitudinal sectional view of an optical fiber cable strain coupled with a carrier tube accordance with one embodiment of the present invention.

FIG. 2B is a cross sectional view of an optical fiber cable strain coupled with a carrier tube accordance with one embodiment of the present invention.

FIG. 3 is a cross sectional view of is a longitudinal sectional view of a optical fiber cable strain coupled with a carrier tube accordance with another embodiment of the present invention.

### DETAILED DESCRIPTION

In one or more embodiments of the present invention, a hardenable fluid material is used to fill a carrier in which an optical fiber or wire is installed. The hardenable fluid material can be one of various materials or a combination thereof, which stay in a fluid state during the pumping operation, and are solidified after completion of the pumping operation. For example, the hardenable fluid material may be a curable resin or wax. The solidification can occur either naturally, or as an artificially controlled process. The artificially controlled process can be, for example, a heating process, a cooling process, a process of adding a chemical agent or a catalytic substance, or a process of loading a physical stress to the hardenable fluid material.

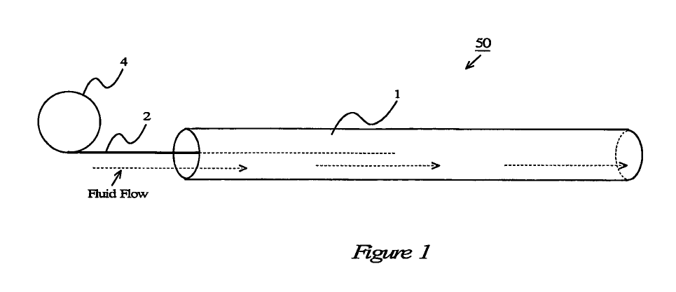

Referring initially to FIG. 1, a schematic drawing of a system for installing an optical fiber cable through a carrier tube in accordance with one embodiment of the present invention is shown. In the embodiment, the system 50 includes a carrier tube 1, an optical fiber cable 2, a cable holder 4, and a fluid providing unit (not shown). The system 50 can also be, for example, deployed adjacent to or in a pipeline. The system 50 can be applied to monitoring distributed environmental parameters along the length of the wellbore. The environmental parameter can be, for example, strain, temperature, pressure, acoustic energy, electric current, magnetic field, electric field, or a combination thereof.

The carrier tube 1 extends into the wellbore along the pipeline, and configured to accommodate the optical fiber cable 2. The cable holder 4 including a drum mechanism is capable of reeling the optical fiber cable 2 in/out. For installing the optical fiber cable 2 in the carrier tube 1, the cable holder 4 reels out and inserts it into the carrier tube 1. The fluid providing unit pumps a hardenable fluid material into the carrier tube 1 concurrently with the insertion of the optical fiber cable 2 into the carrier tube 1. Drag from the fluid flow can help to pull the optical fiber cable 2 into the carrier tube 1.

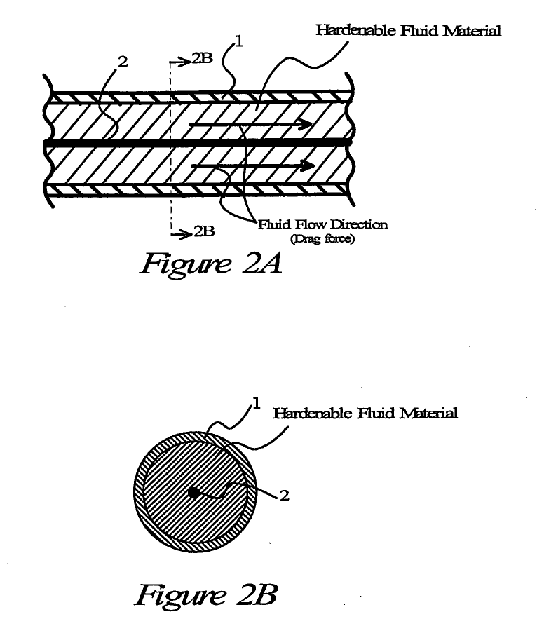

In FIGS. 2A and 2B, a longitudinal sectional view and a cross sectional view of the optical fiber cable 2 strain coupled with a carrier tube in accordance with one embodiment of the present invention are shown. FIG. 2B illustrates a cross sectional view of the optical fiber 2 taken substantially along line 2B-2B of FIG. 2A. As shown in FIGS. 2A and 2B, when the optical fiber cable 2 is inserted into the carrier tube 1 concurrently with the injection of the hardenable fluid, the fluid flows in the arrowed direction, and its drag force leads the optical fiber cable 2 in the same direction.

After completion of the installation process of the optical fiber cable 2, the hardenable fluid is hardened into a solid state (solid state material), which allows strain coupling between the optical fiber cable 2 and the carrier tube 1 over the entire length of the optical fiber cable 2. As shown in the cross sectional view of FIGS. 2A and 2B, the solid state material, contacting the inside wall of the carrier tube 1 and peripheral surface of the optical fiber cable 2, builds a structure providing continuous strain coupling between the carrier tube 1 and the optical fiber cable 2 over the entire length of the optical fiber cable 2 (e.g., for Brillouin OTDR (distributed) or Michelson interferometer (integrating) measurement applications).

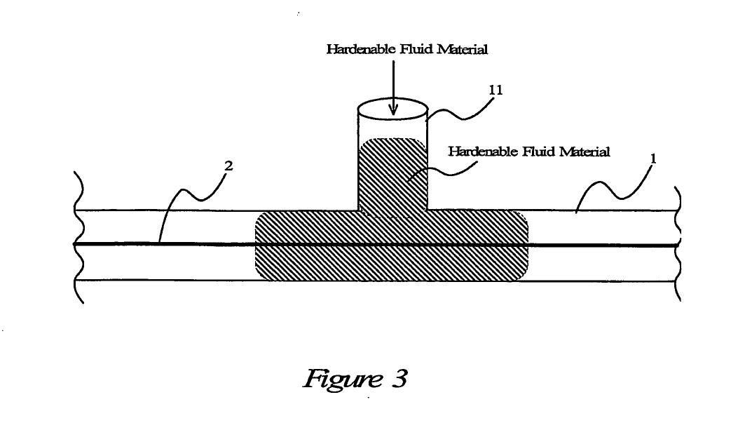

In another embodiment, the strain sensing structure can be constructed at one or more predetermined points along the carrier tube. For example, referring now to FIG. 3, a cross sectional view of an optical fiber cable 2 strain coupled with a carrier tube 1 accordance with another embodiment of the present invention is shown. In this embodiment, injection ports 11 are disposed at predetermined points along the carrier tube 1, and the hardenable fluid is injected into the carrier tube 1 using the injection ports 11. Water or alcohol may be used to place the optical fiber cable 2 into the carrier tube 1. Afterward, the hardenable fluid can be provided through the injection ports 11 at predetermined points of the carrier tube 1. In this configuration, the environmental parameter can be measured at specific points where the injection ports 11 are preinstalled. This configuration is particularly useful for point-sensing strain measure applications, such as Fiber Bragg Gratings. In this case the volume of hardenable fluid injected at each point could be used to control the extent of the region of strain sensitivity.

Further, after completion of the installation process, the hardenable fluid is solidified to build a structure providing strain coupling between the carrier tube 1 and the optical fiber cable 2 over the entire length of the cable, or the predetermined point(s). Accordingly, the optical fiber cable 2 functions as a sensing element without other sensing devices for sensing the physical environmental parameter around the carrier tube 1 along the entire length of the cable 2, or the predetermined point(s).

The mechanical expansion or contraction of the hardenable fluid material during the hardening process could provide a “bias” on the strain measurement. This may potentially extend the useable range of strain measurement.

Furthermore, the solid state material, which is made from the hardenable fluid, around the cable functions as not only a part of the strain coupling structure, but also a sealing material to protect the cable from damage caused by physical impacts and pressure.

The optical fiber applied to one or more embodiments in the present invention can be selected from various types or a combination thereof. For example, a multi-mode optical fiber, a single-mode optical fiber, a graded-index optical fiber, a step-index optical fiber, a birefringent polarization-maintaining fiber, or a photonic crystal fiber may be used for other distributed or point sensing technologies, not just optical fiber. Further, the disclosure herein may be applied to other sensing technologies. For example, an electrical wire with separate sensors may be used instead of optical fiber.

The solidification process of the hardenable fluid can be controlled based on various methods such as the use of chemical activators and other additives to the hardenable fluid, heat controls, and the pumping rate of the hardenable fluid controlled by the fluid providing unit. For example, a two-pack epoxy may be used as the hardenable fluid. The proportion of hardener may be varied to adjust the cure rate to correspond with the amount of time it takes to place the optical fiber cable. Further, heat can be used to initiate a hardening reaction. For example, electric current can be used through the carrier tube made from metal, or by localized heating (e.g., induction heating or electric heater) to control the timing of the solidification of the hardenable fluid. In one embodiment, the hardenable fluid may be hot wax. After injection of the wax in liquid form, the wax can naturally cool and harden, or a coolant can be pumped to accelerate cooling of the wax to the solid state.

Those having ordinary skill in the art will appreciate that may materials are available for the hardenable fluid material. The selection of the hardenable fluid material depends mostly on the material properties, such as modulus and thermal expansion, and the physical environment in which the carrier tube is to be deployed.

The material may be selected based on a preferred strain measurement range and offset. The diameter of the carrier tube may be determined based on a preferred strain coupling level between the cable and the carrier tube.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of installing a cable for the measurement of a physical parameter, the method comprising:
providing a cable configured to measure a physical parameter at at least one one point;
inserting the cable into a carrier tube;
injecting a hardenable fluid into the carrier tube; and
hardening the hardenable fluid to be in a substantially solid state.

2. The method of claim 1, wherein the inserting the cable into the carrier tube is performed at least in part by drag force from the injection of the hardenable fluid.

3. The method of claim 1, wherein the cable comprises an optical fiber.

4. The method of claim 1, wherein the hardenable fluid material is one of a curable resin and a wax.

5. The method of claim 1, wherein the cable is configured to measure a physical parameter at a plurality of points along the carrier tube

6. The method of claim 5, wherein the physical parameter is strain.

7. The method of claim 5, wherein the hardenable fluid is injected at a plurality of predetermined points provided along the carrier tube.

8. A system for the measurement of a physical parameter, the system comprising:
a carrier tube;
a cable disposed in the carrier tube and configured to measure strain at at least one point around the carrier tube; and
a hardenable fluid material provided around the cable to allow strain coupling between the cable and the carrier tube.

9. The system of claim 8, wherein the cable is adapted to measure strain at a plurality of points along the carrier tube.

10. The system of claim 8, wherein the cable comprises an optical fiber.

11. The system of claim 8, further comprising a plurality of injection ports along a longitudinal direction of the carrier tube.

12. The system of claim 8, wherein the hardenable fluid material is one of a curable resin and a wax.
